(19) United States
(12) Patent Application Publication
(10) Pub. No.: US 2024/0242278 A1
(43) Pub. Date: Jul. 18, 2024

(54) Estimation of the Fair Market Value of Credit Default Swaps Under Uncertainty and Imprecision

(71) Applicants: John T. Rickard, Larkspur, CO (US); James G. Rickards, Portsmouth, NH (US)

(72) Inventors: John T. Rickard, Larkspur, CO (US); James G. Rickards, Portsmouth, NH (US)

(73) Assignee: Royalty & Streaming Advisors Holdings, LLC, Portsmouth,, NH (US)

(21) Appl. No.: 18/495,250

(22) Filed: Oct. 26, 2023

Related U.S. Application Data
(63) Continuation-in-part of application No. PCT/US2023/010482, filed on Jan. 10, 2023.

(51) Int. Cl. G06Q 40/04

(52) U.S. Cl. CPC G06Q 40/04

(57) ABSTRACT

Credit default swaps (CDSs) are instruments providing default protection for credit instruments such as bonds and collateralized debt obligations (CDOs). CDSs embody a contingent stream of payments whose fair market value (FMV) depends upon parameters involving uncertainty and imprecision. They are traded over-the-counter (OTC) with investment banks and insurance companies and institutions such as sovereign wealth funds, pension funds and others. In addition, there exists a market in CDSs where the buyer does not own the debt instrument but speculates upon default, while the seller speculates upon no default. This method models uncertainties and imprecisions in estimating FMV for contingent streams of payments such as CDSs. The resulting FMV is reduced to an interval range. This interval is useful as a negotiation range and provides a nominal scalar FMV. These techniques are computationally very efficient and represent a powerful tool, different in mathematical specifics similar to the Black-Scholes formula.

### CROSS REFERENCE TO RELATED APPLICATIONS

This application is a continuation-in-part application which claims benefit of and priority to International Patent Application PCT/US2023/010482, filed 10 Jan. 2023, where permissible each incorporated by reference in its entirety.

### BACKGROUND

### Field of the Invention

This invention relates generally to the fields of financial instruments involving contingent streams of payments. More particularly, this invention comprises a system and method that provides insurance protection against default events for credit instruments such as bonds and collateralized debt obligations which embody a contingent stream of payments whose fair market value (FMV) is dependent upon multiple parameters involving varying degrees of uncertainty and imprecision as to their values.

### 1.0 Introduction

Credit default swaps (CDSs) are derivative financial instruments that provide insurance protection against default events for the owners of credit instruments such as bonds and collateralized debt obligations (CDOs) [1]. The buyer of a CDS agrees to make a stream of payments (commonly referred to as the “spread” payments) to the seller of the CDS for a defined period of protection, often until the maturity date of the underlying credit instrument, in return for the right to “swap” the latter to the seller for its principal (face) value in the event of a default occurring during this period.

A default is an event where the underlying credit instrument ceases to fulfill the terms of its contract, most often its interest and principal payment obligations. There are additional, less common, credit events that also legally constitute a default, such as restructuring of credit obligations, government intervention, etc. Defaults on a particular credit instrument are adjudicated by the International Swaps and Derivatives Association (ISDA) Error! Reference source not found., which is the international industry governing body.

In the event of a default, the CDS buyer is reimbursed by the seller for the full principal value of the underlying credit instrument, with no further obligations to make the spread payments, while the seller receives the underlying debt instrument (which may have some residual value). Thus, in a default situation, the buyer and seller have “swapped” places, with the CDS seller now owning the underlying credit instrument and the buyer having been reimbursed for their original investment in this instrument.

CDSs are traded over the counter (OTC) rather than on registered exchanges, with the sellers typically being large investment banks and the buyers being institutions such as sovereign wealth funds, state pension funds, insurance companies and other investors holding debt portfolios. CDSs are used ubiquitously to hedge the risk of default on credit instruments, especially those having higher yields and the concomitant higher risk of default.

In addition to entities that desire protection of their credit instrument portfolios, there also exists a large market in CDSs where the buyer does not actually own an underlying credit instrument but is speculating upon its default, while the seller is speculating upon no default occurrence. In these cases, a default event results in a cash settlement, with the buyer receiving the credit instrument principal value from the seller, but with no actual swap of a credit instrument. The total market for CDSs is not transparent but is estimated to be in the trillions of dollars in face value of the underlying credit instruments.

CDSs embody a contingent stream of payments whose fair market value (FMV) is dependent upon multiple parameters involving varying degrees of uncertainty and imprecision as to their values. While it is possible in principle to estimate a scalar value of the FMV of CDSs, given precise knowledge of the parameters involved [3], the latter assumption is of course unrealistic.

Given the size and ubiquity of the CDS market, it is very important to have an appropriate estimate of the fair market value (FMV) of CDSs for purposes of transaction negotiations, proper accounting, hedging, arbitrage, and/or trading. This is especially important when there is asymmetry in the knowledge pertaining to the involved parameters between the buyers and sellers of these instruments. For any given CDS, there are numerous such parameters, including the probabilities of default by period, the appropriate discount factors to apply to future spread payments by period, and the unknown recovery rate for a defaulted credit instrument. Given this multiplicity of input factors, and the accompanying imprecise knowledge of these factors, CDS valuation negotiations often tend to be highly bespoke and thus potentially more favorable to a financially more sophisticated party on one side of the negotiation.

Current approaches to estimating the FMV of these instruments typically deal with the uncertain, imprecise knowledge of these parameters using spreadsheet type calculations, where numerous different choices of point values for the elements of the parameter sets are selected to get a sense of the range of “nominal” values of the FMV, or through the employment of computationally intensive Monte Carlo simulation methods. The high dimensionality of this type of problem, combined with the imprecise knowledge of the appropriate probabilistic models for the uncertainty in each parameter, generally makes a Monte Carlo simulation approach unattractive due to the enormous number of iterations required to obtain statistical significance even for a single set of assumptions.

The techniques proposed in this paper enable a rich alternative modeling of the uncertainties and imprecisions involved in estimating the FMV for contingent streams of payments such as CDSs, resulting in an analytically derived distribution of their FMV that can be further analytically reduced to an interval range of values. This interval is useful as a negotiation range between buyers and sellers of these derivative instruments and the interval midpoint provides a nominal scalar FMV, considering all the uncertain and imprecise knowledge of the parameters involved.

Our approach is computationally very efficient in comparison to Monte Carlo methods and represents quite a general and powerful tool, different in its mathematical specifics but analogous to the Black-Scholes formula for option pricing in its broad applicability. In fact, we have applied a similar approach to the latter problem of options pricing under uncertain and imprecise knowledge of the involved parameters, as described in [4].

A particular feature of our approach is that it can incorporate inputs from multiple human experts. Human expertise is particularly valuable in situations where no large database of highly comparable credit instruments exists, which is often the case with riskier credit instruments. Subject matter experts (SMEs) in the appropriate financial domains for a given credit instrument can often provide interval estimates of the parameter values for the requisite variables based upon their expert assessments, and indeed this is likely the best and most general starting point for estimating a FMV.

The interval ranges for the probabilities of no default and for the recovery rate in the event of default would rely upon financially specific domain expertise for the underlying instrument.

The interval ranges for the discount factors would be derived from expert assessments of the discounted present value of future payments. Different SMEs will invariably provide different interval range estimates for each attribute, reflecting the inherent imprecision associated with human forecasts.

What is needed is an analytical method for FMV estimation that can incorporate multiple SME interval estimates of the fundamental parameter values involved in such calculations and can propagate the implicit imprecision and variability of these interval estimates over multiple time periods and aggregate them into a corresponding representation of an estimated range of the FMV. We provide such a method in this invention, using an ab initio derivation.

### SUMMARY OF THE INVENTION

The present invention provides an analytical approach to FMV estimation that can: a) incorporate multiple SME interval estimates of the fundamental parameter values involved in such calculations and b) can aggregate the implicit imprecision and variability of these interval estimates into a corresponding representation of the uncertainty and imprecision in an estimated range of the FMV. We provide such an approach in this paper.

We begin in Section 2 by deriving the scalar FMV for a CDS using known techniques [3] that require precise knowledge of each input parameter involved. This lays the theoretical foundation for our subsequent generalizations.

Section 3 introduces the relatively recent technology of interval type-2 (IT2) fuzzy membership functions (MFs) [5] as a representation of imprecise knowledge for a parameter. These IT2 MFs are more general than a probability distribution, as they combine both primary and secondary uncertainty of each parameter value. We describe a technique whereby IT2 MFs can be constructed from a collection of one or more interval range estimates for each parameter provided by SMEs.

We then describe how calculations are performed using IT2 MFs. These calculations are vastly less computationally intensive than Monte Carlo simulations, and the resulting IT2 MF representation of FMV provides a full primary and secondary representation of the uncertainty and imprecision in this estimate. IT2 MFs can be analytically reduced to a corresponding interval range, whose midpoint provides a notional scalar value, using an operation known as type-reduction as described in [5], [6].

Section 4 generalizes the scalar FMV results derived in Section 2 by using IT2 MFs in the place of scalar values for each parameter to calculate the corresponding IT2 MF of the FMV of a CDS. This output MF provides the most general representation of the uncertainty and imprecision in the FMV. The analytical type-reduction of the FMV IT2 MF to an interval range is useful for negotiations between parties to arrive at an agreed final valuation of spread payments for the corresponding CDS. We provide an example of these computations in Section 4.

Section 5 describes applications of our techniques and concludes.

### BRIEF DESCRIPTION OF THE FIGURES

FIG. 1 Illustration of an IT2 fuzzy MF for an uncertain probability value P. As shown in this figure, the membership interval of the probability value 0.65 ranges from about 0.3 to 0.7, reflecting a lower range of membership of this particular value, whereas probability values around 0.63 have full membership, i.e., the collapsed interval [1,1].

FIG. 2 Illustration of α-cuts of the upper membership function (UMF) and lower membership function (LMF) of the IT2 MF shown. Note that each α-cut is an interval along the x-axis, corresponding to a particular value of a.

FIG. 3 Representing an IT2 MF as a pair of arrays of the corresponding α-cuts of its UMF and LMF.

FIG. 4 Year 1 IT2 MFs for (a) P₁, (b) d₁ and (c) R.

FIG. 5 IT2 MFs for (a) P₅ and (b) d₅.

FIG. 6 IT2 MF of the FMV for a 5-year CDS in bp.

### DETAILED DESCRIPTION OF INVENTION

### 2.0 Scalar Derivation of FMV for Contingent Payment Streams

We begin by deriving a scalar estimate of the FMV for the contingent payment stream involved in a CDS, under the (unrealistic) assumption that all the parameters associated with the estimate are known precisely, i.e., as scalar values. Our derivation follows that in [3].

### 2.1 Input Parameters

The inputs to a CDS FMV evaluation are the a priori probabilities Pᵢ of no default to the i^{th} spread payment period, the future payment discount factors dᵢ, for all periods i=1, . . . ,n, where n is the number of periods for which credit risk protection is sought, and the recovery rate R of a defaulted credit instrument, i.e., the fraction of the face value that can be recovered by the CDS seller upon a transfer of ownership effected by the swap.

The Pᵢ, dᵢ and R values can be arbitrarily specified, with the only constraints being that Pᵢ₊₁≥Pᵢ for all i, since successive probabilities of no default cannot increase with time, and 0≤R≤1. One means of generating the Pᵢ values is through the use of hazard rates λᵢ, where λᵢPᵢ₋₁, is the probability of default in period i, given the probability of no default Pᵢ₋₁ to the period i−1. Thus, we have by iteration,

Pᵢ=(1-λ₁)(1−λ₂) . . . (1-λ₁), (1)

where P₀=1.

### 2.2 Scalar FMV of a CDS

Assume a notional face value of 1 for the credit instrument so that all calculations can be expressed in basis points (bp) per dollar of face value. With these preliminaries, suppose the CDS spread is calculated for n time periods. We define the following terms:
Sₙ=spread payments for CDS protection to time period n per dollar of principal
Δᵢ=length of payment time period i in years (3)
Pᵢ=probability of no default to time period i (4)
dᵢ=discount factor for CDS spread in period i (5)
R=recovery rate for the bond upon default (6)

At commencement of the CDS, a no-arbitrage argument requires that the expected discounted present value of the spread payment stream (i.e., assuming no default) E[DPV (Sₙ)|nodefault] plus the expected discounted present value of accrued spread payments in the event of default E[DPV (Sₙ|default)] be equal to the expected discounted present value of the principal loss upon default, E[DPV (1−R)].

This relationship can be expressed in the following equation:

$${S}_{n} {\sum }_{i = 1}^{n} {Δ}_{i} {P}_{i} {d}_{i} + {S}_{n} {\sum }_{i = 1}^{n} \frac{{Δ}_{i}}{2} {( {P}_{i - 1} - {P}_{i} )}_{i} {d}_{i} = ( 1 - R ) {\sum }_{i = 1}^{n} ( {P}_{i - 1} - {P}_{i} ) {d}_{i} \qquad ( 7 )$$

The ½ in the summand of the second term on the left is due to the averaging over Δᵢ of when the spread payments halt during that time period, given that payments do halt during that period. The terms (Pᵢ₌₁−Pᵢ)≥0 represent the differences in the successive a priori probabilities of default in period i (i.e., the probability of no default to period i−1 followed by default in period i).

Equation (7) essentially states that the sum of the expected discounted present value of payments received by the CDS seller under either occurrence must equal the expected discounted present value of her loss 1−R upon default, so that the swap has a zero expected value at inception.

Rearranging (7) to solve for Sₙ, we obtain

$$\frac{{S}_{n}}{2} {\sum }_{i = 1}^{n} {Δ}_{i} ( {P}_{i - 1} + {P}_{i} ) {d}_{i} = ( 1 - R ) {\sum }_{i = 1}^{n} ( {P}_{i - 1} - {P}_{i} ) {d}_{i} . \\ Thus , \qquad ( 8 )$$

$${S}_{n} = \frac{2 ( 1 - R ) {\sum }_{i = 1}^{n} ( {P}_{i - 1} - {P}_{i} ) {d}_{i}}{{\sum }_{i = 1}^{n} {Δ}_{i} ( {P}_{i - 1} + {P}_{i} ) {d}_{i}} , \qquad ( 9 )$$

where we multiply this result by 104 to obtain its value in bp.

It is instructive to examine the extreme values for Sₙ in (9) as a function of the recovery rate R and the probabilities Pᵢ. As R→0, i.e., the defaulted credit instrument recovery rate approaches zero, the numerator of (9) approaches its maximum value, so that intuitively, the spread payments for a given set of the remaining variables are maximized when there is no recovery value in the credit instrument in the event of default.

At the other extreme where R→1, the numerator of (9) approaches zero, implying that Sₙ→0, since with a full recovery rate there is no risk of loss to the seller of the CDS even if the credit instrument defaults and the swap is exercised.

For a given value of 1−R in (9), as all the hazard rates λᵢ in (1) approach zero, Pᵢ→1 for all i, and thus the numerator approaches zero. In this situation, where there is a vanishingly small probability of default, the spread payments will of course approach zero since the CDS seller is incurring a vanishingly small risk of default.

On the other hand, if P₀=1 and P₁=0 at time 0+, i.e., default is both certain and immediate, then the ½ averaging factor in the second term on the left side of (7) goes away due to the immediacy of the default, and (7) collapses to:

SₙΔ₁d₁=(1−R)d₁,

or

Sₙ=1−R, since Δ₁=1. (10)

In this case, the seller of the CDS has an assured loss of 1−R upon liquidation of the credit instrument immediately swapped to him and thus would logically demand a payment of 1−R for agreeing to the swap.

To use some illustrative values, consider a 5-year CDS and suppose that λᵢ=0.0375 for all i, i.e., the hazard rates for default each year are 3.75%. Further suppose the discount factors dᵢ are computed using an annual discount of 8% and that the recovery rate is R=0.35. Substituting the corresponding values for Pᵢ and dᵢ into (9), we obtain an annual CDS spread payment of 248.4 bp. In other words, under these assumptions, the buyer would make spread payments of $2.48 per year to insure against default for a single bond having a principal value of $100.

On the other hand, suppose that we decrease the hazard rates to λ₁=0.0325 with all else remaining unchanged. Then the spread payments are reduced to $2.15 per year. Increasing the hazard rates to λ₁=0.0425 results in a spread payment of $2.82 per year. If instead we have λ₁=0.0375 but reduce the recovery rate to R=0.3, we obtain spread payments of $2.68 per year, while increasing the recovery rate to R=0.4 results in spread payments of $2.29 per year.

From these simple example cases, we see that the spread payments are quite sensitive to the assumptions made for the hazard rates and recovery rates, which are the least precisely known parameters in (9). Small variations in these values can produce significant variations in the scalar spread calculation. Thus, it behooves us to have a method of calculating a FMV for the CDS spread payments that takes account of the uncertainty and imprecision in our knowledge of these parameters. The next section describes our approach to dealing with this problem.

### 3.0 Generalizations to Account for Uncertainties and Imprecision

In the real world, knowledge of all the future parameters involved in calculating the FMV for a contingent stream of payments is inherently imprecise. Traditionally, this lack of precision is characterized as random uncertainty and is typically addressed using Monte Carlo simulations, where assumptions are made about the (imprecisely known) probability distributions for each input parameter and pseudo-random draws are made over these distributions to obtain a particular realization of the FMV. The outcomes of many such realizations are then used to estimate a corresponding probability distribution of the FMV.

Due to the number of parameters involved, millions of such realizations must be generated to obtain a statistically valid estimate of the output probability distribution of the FMV calculation, from whence we can compute an average value with its corresponding uncertainty (e.g., standard deviation). The required number of realizations in the simulation increases exponentially with the number of input parameters due to the “curse of dimensionality,” since we must generate enough multivariate realizations to account for the imprecisely known statistical variability of each dimension. And of course, the results of the simulation depend critically upon the legitimacy of the assumed probability distributions for each parameter. A change in any one of these distributions requires a repeat of the Monte Carlo simulation.

### 3.1 Modeling Uncertainty and Imprecision Using IT2 Fuzzy Membership Functions

Fortunately, there is a much better way to analyze such problems, using IT2 fuzzy MF representations of the input parameters, followed by a corresponding calculation of the fuzzy MF of the FMV [5][6]. By using these MFs to represent all parameters, we can account not only for the primary distribution of the imprecision in our knowledge of each parameter, analogous to the probability distribution assumptions required in a Monte Carlo analysis, but also for our imprecise knowledge of these primary distributions.

This is analogous to employing secondary probability distributions for modeling the uncertain knowledge of the “primary” probability distribution parameters in a Monte Carlo simulation, which of course compounds the complexity of the simulation to a degree making it computationally unattractive.

In contrast, the FMV calculations using the IT2 approach can be carried out on a laptop computer in a few seconds or less. To those unfamiliar with IT2 fuzzy representations, we will use figures to illustrate this method, after which it will become obvious what these representations describe. We will also use figures to describe the way calculations are performed using these IT2 MFs in Section 3.2

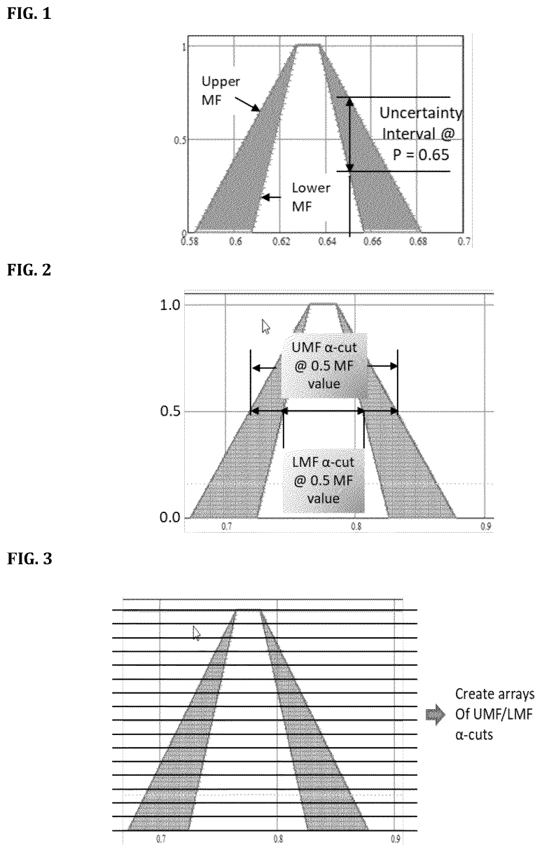

FIG. 1 illustrates an IT2 fuzzy MF, with its associated upper MF (UMF) and lower MF (LMF), i.e., the upper and lower bounding curves. The interpretation of an IT2 MF is as follows: the horizontal extent shows the support of the respective UMF and LMF functions, and the corresponding “footprint of uncertainty” (FOU) is the shaded area between the two curves.

If we take a vertical slice through the IT2 MF at any particular value of x on the horizontal axis, the range of values over which this slice intersects the FOU (an interval with endpoints between 0 and 1) indicates the range of secondary imprecision in our knowledge of the corresponding parameter at this value of r. (This is analogous to having uncertain knowledge about a parameter in a probability distribution.)

As in the case of probability distributions used in Monte Carlo simulations, assumptions must be made regarding the functional forms of these IT2 MFs, with the constraint that LMF (x)≤ UMF(x) for all values of x. However, the very structure of these MFs allows us naturally to represent the compound imprecision (primary and secondary) in our knowledge of these parameters, and to perform calculations rapidly in response to changes in these assumptions.

Referring to (9), there are three sets of parameters whose future values are imprecisely known for the contingent payment stream of a CDS: Pᵢ and dᵢ for i=1 . . . . ,n, and R. Thus, for example, in the case of a 10-year duration of a CDS, there are 21 such parameters. In real-world cases, the corresponding IT2 MFs are calculated from sets of interval range estimates supplied by one or more SMEs for each parameter using the techniques described in [7]. Solely for purposes of illustration in this paper, we shall employ a simple and straightforward construction method described below for the generation of trapezoidal IT2 MFs such as that shown in FIG. 1.

We first specify the support intervals of the UMF for each value of Pᵢ and dᵢ, for i=1 . . . . ,n, and a single support interval for the recovery rate R, i.e., the intervals over which their corresponding UMFs have non-zero values. These UMF support intervals bound the extreme range of values for each parameter. Next, we specify the fraction of these support intervals over which the fuzzy MF values are unity for both the UMF and the LMF. This smaller interval can be viewed as the range of values considered most representative of the corresponding parameter. Finally, we specify the fraction of the UMF support intervals representing the support intervals for their corresponding LMFs.

In the following, we use values of 10% and 50%, respectively, for these percentages. These rules are of course an arbitrary means of generating the corresponding MFs, but they provide an intuitive method for this process. To emphasize, our approach can accommodate arbitrarily defined MFs for all quantities and can perform the prescribed calculations in seconds for a given case.

### 3.2 Calculating with IT2 Membership Functions

Calculations involving IT2 MFs are performed using “α-cuts” [5][6] of the associated upper and lower MFs. An α-cut is the interval corresponding to a horizontal slice of the UMF (or LMF) at a particular value of membership α in the interval [0,1]. FIG. 2 illustrates an α-cut of the UMF and LMF of an IT2 MF at an α value of 0.5 membership.

If we calculate arrays of the UMF and LMF α-cuts of an IT2 MF at sufficiently small increments of a ranging from 0 to 1, the resulting pair of α-cut arrays is a good representation of the overall MF. FIG. 3 notionally illustrates this process of calculating α-cut slices. In practice, we typically use a increments of 0.01 to compute these α-cuts, resulting in 101 α-cuts in the interval [0,1], including both endpoints of this interval. Thus, we see that the union of all the UMF and LMF α-cuts of an IT2 MF is an approximate representation of the full MF, with the approximation becoming more exact as the number of α-cuts increases.

From continuity arguments, we conclude that the equation for Sₙ in (9) also has interval values when one or more of its input variables have interval values. Once the α-cut arrays are computed for each IT2 MF of the parameters involved in a formula such as (9), we use the interval endpoints of corresponding α-cuts to calculate the minimum and maximum values of the corresponding α-cuts of the CDS spread IT2 MF.

This same general approach can be used for any mathematical formula involving interval operations.

In the present case, we cannot calculate analytically the left- and right-hand endpoints of the α-cut intervals for S, due to the summation of terms involving Pᵢ₋₁ and Pᵢ in both the numerator and denominator. However, we can employ a nonlinear constrained optimization algorithm to find the minimum and maximum values of each α-cut interval of the MF of Sₙ, subject to the interval constraints on the input parameters. Optimization algorithms to perform these operations are standard components of mathematical programming libraries, and they provide extremely fast numerical evaluations of maxima and minima over the corresponding α-cut interval bounds.

Using this approach, we assemble the arrays of the α-cuts for the resultant IT2 MF of FMV of the CDS spread payments Sₙ into an α-cut representation of the UMF and LMF of this MF. The analytical “type-reduction” of this IT2 MF into a best interval estimate for the CDS spread payments is performed using the Karnik-Mendel algorithm as described in [5][6]. The resulting interval is analogous to an “error range” for the subject IT2 MF. The center of this interval provides a nominal scalar representation of the IT2 MF.

### 4.0 Example Calculations of the CDS Spread Payments

With these preliminaries, and to illustrate the above method, let us assume the interval ranges shown in (11) for the input parameters for a 5-year CDS, where the discount rate intervals dᵢ are computed assuming an annual interest rate uncertainty interval of [0.04 0.1], i.e., a 4% to 10% range.

$$P = [ \begin{matrix}0.85 & 0.98 \\ 0.82 & 0.95 \\ 0.79 & 0.92 \\ 0.76 & 0.89 \\ 0.73 & 0.86\end{matrix} ] d = [ \begin{matrix}0.095 & 0.961 \\ 0.819 & 0.923 \\ 0 \text{.741} & 0.887 \\ 0.67 & 0.852 \\ 0.607 & 0.819\end{matrix} ] R = [ 0.3 0.4 ] \qquad ( 11 )$$

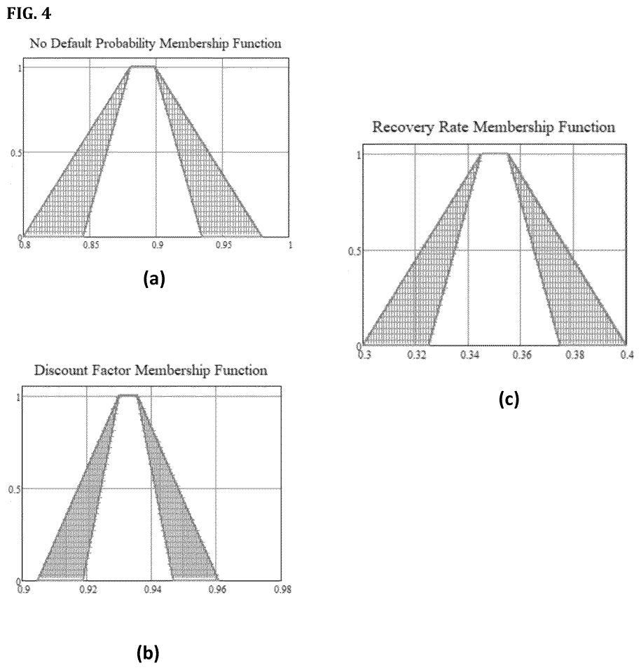

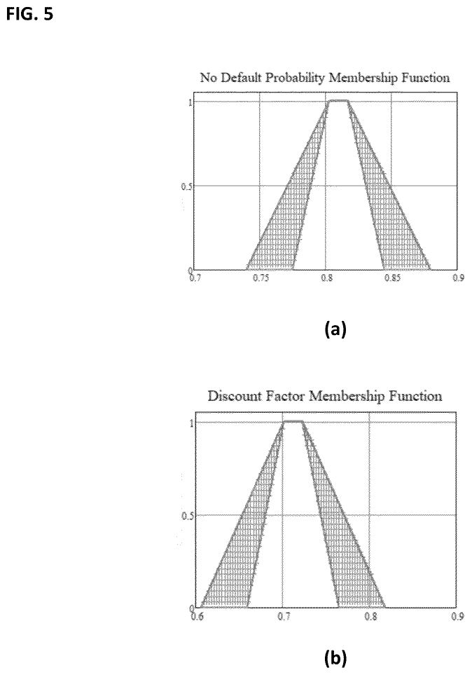

Using these interval ranges in conjunction with the UMF and LMF generation method described above, we now illustrate the computation of the resulting IT2 MF for the CDS spread payments. The first step is to compute the IT2 MFs for each parameter for each year. FIGS. 4(a)-(c) show the year-1 IT2 MFs for P₁, d₁, and R.

Thus for example in FIG. 4(a), if we select the value x=0.89, the range of secondary imprecision is the collapsed interval [1,1], indicating this value of x is highly representative for P₁, whereas if we take x=0.93, the corresponding vertical slice interval is roughly [0,0.65], indicating that the value x=0.93 has both lower degrees of confidence in being a representative value for P₁, and greater imprecision in assessing this degree of confidence, due to the large range of secondary values.

Overall, there is an interval range of values of x centered around x=0.89 in FIG. 4(a), for which we have highly representative values for P₁, and a much larger range of values of x outside the latter interval in which we have lesser (and varying) degrees of confidence for being a valid value for P₁. Similar comments apply to the IT2 MFs for the discount factor dᵢ in year 1. Note that the IT2 MF for R will remain unchanged over the CDS period, although we could easily make this MF variable over each year if desired.

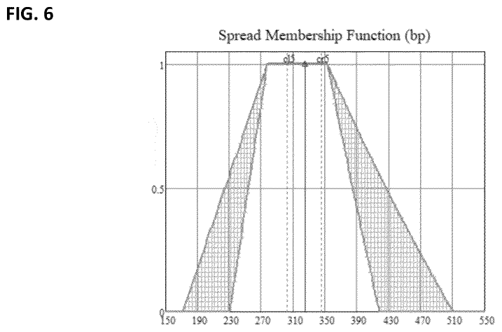

Going to the final year 5, the corresponding MFs for P₅ and d₅ are shown in FIGS. 5(a)-(b). As noted from (11), the support interval of the UMF for P₅ has declined to a range of [0.74,0.88] and the support interval of the UMF for d₅ has declined to about [0.61,0.81],

reflecting lower values for the no default probability and higher values of the discount factor, respectively.

Now assume as mentioned previously that we use 101 α-cuts to discretize the IT2 MFs, i.e., we employ α^{(j)} increments of 0.01 such that

$${α}^{( j )} = j / 100 for j = 0 , … , 100 ,$$

where the superscript (j) refers to the j^{th} α-cut. Then for each corresponding IT2 UMF and LMF α-cut interval [αP_{i,0}^{(j)},αP_{i,1}^{(j)}], [αd_{i,0}^{(j)},αd_{i,1}^{(j)}] for pᵢ, dᵢ, i=1, . . . , 5, and for the corresponding α-cut intervals of the IT2 MF of R, i.e., [R₀^{(j)},R₁^{(j)}], for j=0, . . . ,100 in all cases, we solve the following set of nonlinear constrained minimization and maximization problems to obtain the resulting left and right hand interval bounds [αCDS₀^{(j)},αCDS₁^{(j)}], j=0, . . . ,100, for the j^{th} α-cut of the UMF and LMF of the CDS spread IT2 MF:

$$Given : \\ \begin{matrix}α {P}_{1 , 0}^{( j )} \leq {p}_{1}^{( j )} \leq α {P}_{1 , 1}^{( j )} & {p}_{1}^{( j )} \geq {p}_{2}^{( j )} & α {d}_{1 , 0}^{( j )} \leq {d}_{1}^{( j )} \leq α {d}_{1 , 1}^{( j )} \\ α {P}_{2 , 0}^{( j )} \leq {p}_{2}^{( j )} \leq α {P}_{2 , 1}^{( j )} & {p}_{2}^{( j )} \geq {p}_{3}^{( j )} & α {d}_{2 , 0}^{( j )} \leq {d}_{2}^{( j )} \leq α {d}_{2 , 1}^{( j )} \\ α {P}_{3 , 0}^{( j )} \leq {p}_{3}^{( j )} \leq α {P}_{3 , 1}^{( j )} & {p}_{3}^{( j )} \geq {p}_{4}^{( j )} & α {d}_{3 , 0}^{( j )} \leq {d}_{3}^{( j )} \leq α {d}_{3 , 1}^{( j )} \\ α {P}_{4 , 0}^{( j )} \leq {p}_{4}^{( j )} \leq α {P}_{4 , 1}^{( j )} & {p}_{4}^{( j )} \geq {p}_{5}^{( j )} & α {d}_{4 , 0}^{( j )} \leq {d}_{4}^{( j )} \leq α {d}_{4 , 1}^{( j )} \\ α {P}_{5 , 0}^{( j )} \leq {p}_{5}^{( j )} \leq α {P}_{5 , 1}^{( j )} & & α {d}_{5 , 0}^{( j )} \leq {d}_{5}^{( j )} \leq α {d}_{5 , 1}^{( j )}\end{matrix} \\ Find \\ α {CDS}_{0}^{( j )} = {min}_{{p}^{( j )} , {d}^{( j )}} [ S ( {p}^{( j )} , {d}^{( j )} , {R}_{1}^{( j )} ) ] \\ α {CDS}_{1}^{( j )} = {max}_{{p}^{( j )} , {d}^{( j )}} [ S ( {p}^{( j )} , {d}^{( j )} , {R}_{0}^{( j )} ) ] \qquad ( 12 )$$

where S(p,d,R) is the scalar CDS spread function defined by (9), for n=5 in this example. Note that the leading subscripts of 0 and 1 in our notation above refer to the left- and right-hand boundaries of the corresponding α-cut intervals, respectively, and for notational simplicity, we have avoided distinguishing between the UMF and LMF calculations, which are performed separately but involve the same formulation in (12). While these calculations may appear to be very intensive, the full set of them for all values of the indexes i and j for both the UMF and the LMF run on a laptop computer in a few seconds, due to the efficiency of the optimization routines.

Performing the requisite calculations on the α-cuts of the input IT2 MFs resulting from our construction method described in Section 3.1, and using the support intervals given in (11) for Pᵢ, dᵢ, i=1, . . . , 5, where i indexes the rows of P and d, and for the single row of R, we obtain the α-cuts of the IT2 MF of the FMV of the CDS spread payments. From these α-cuts, we directly construct the IT2 MF shown in FIG. 6, where the x axis is in basis points.

The centroid interval of the IT2 MF of the CDS spread is calculated analytically as [303, 346] bp and is illustrated by the vertical dashed line in this figure. This centroid interval represents a reasonable negotiation range for the CDS spread payments, given the uncertainty and imprecision in all the inputs. The center of the centroid interval, at 325 bp, represents the nominal scalar FMV of the CDS spread payments.

Note however that the IT2 MF support interval of the UMF of the CDS spread FMV extends over a considerably larger range of values, i.e., an interval of [170.510] bp, which illustrates the implications of incorporating the full imprecisions in our knowledge of the input parameters. This result highlights the desirability of our approach to estimating the CDS spread FMV

### 5.0 Applications

The most immediate application of the techniques described in this paper is to facilitate negotiations between buyers and sellers of CDSs. Even in cases where there is a wide range of values in the centroid interval, its upper and lower values act as reasonable boundaries on the negotiation price and provide leverage to a party whose negotiating position might otherwise be weak. This helps to negate overreaching by the stronger party and to support fair resolutions.

Beyond negotiations between the owner of a credit instrument and the CDS seller, our techniques will be of substantial value to parties in speculative investing in these instruments.

Our approach can also be used by accountants, appraisers, and bankers in advising and financing the buyers and sellers of CDSs. Finally, investment bankers can use this valuation technique in assessing merger or acquisition prospects for clients.

Over time, improved valuation techniques have been shown to reduce transaction costs, improve liquidity, and facilitate price discovery in markets.

### 6.0 Conclusion

This invention describes a method for the analytical derivation of the FMVs of CDS spreads, taking account of the uncertain and imprecise knowledge of all input factors, including the no default probabilities Pᵢ, the discount factors dᵢ, and the recovery rate R.

We first derive the FMVs of these instruments using scalar values for all inputs, following that in [3], which presumes precise knowledge of these inputs. We then generalize this result to the case where all input values are imprecisely known and are represented using IT2 MFs, which capture both the primary and secondary imprecision in our knowledge inherent to these inputs. We illustrate these calculations using a conveniently synthesized set of IT2 MFs for these various inputs, but the approach is applicable to arbitrary choices for these inputs.

The calculations involved are straightforward to implement and are vastly less numerically intensive than would be required for Monte Carlo simulations of the model uncertainties.

Although the present invention has been described with reference to specific embodiments, workers skilled in the art will recognize that many variations may be made therefrom. Thus, a system and method for analytical derivation of FMVs is disclosed in the embodiments herein. Accordingly, other objects and advantages of the invention will be apparent to those skilled in the art from the detailed description together with the claims.

### REFERENCES

[1] What is a credit default swap (CDS)? Investopedia (2022). https://www.investopedia.com/terms/c/creditdefaultswap.asp
[2] International Swaps and Derivatives Association (ISDA), https://www.isda.org/.
[3] Credit derivatives handbook, JPMorgan publication (2008).
[4] Rickard, J. T, J. Rickards and T. Bowens (2022) “Estimation of the fair market value of royalties, options on royalties and streaming contracts under uncertainty and imprecision,” submitted to SME Mining, Metallurgy and Exploration Journal.
[5] Mendel, J. (2001) Uncertain Rule-Based Fuzzy Logic Systems. Upper Saddle River, NJ: Prentice-Hall.
[6] Mendel, J. and D. Wu (2010) Perceptual Computing. Hoboken, NJ: John Wiley & Sons, Inc.
[7] Hao, M. and J. M. Mendel (2016) “Encoding words into normal interval type-2 fuzzy sets: HM approach,” IEEE Trans. On Fuzzy Systems, vol. 24, no. 4, pp. 865-879

1. A method for estimating a FMV of credit default swap (CDS) as a financial instrument comprising:
a. deriving scalar values for the FMV using precise knowledge inputs;
b. generalizing imprecisely known inputs using IT2 MFs;
c. calculating a set of IT2 MFs for these various inputs using interval data provided by SMEs; and
d. using the IT2 MFs calculated in c. to calculate the corresponding IT2 MF of the FMV,
where this FMV IT2 MF accounts for the uncertainties and imprecise knowledge of all the factors involved in the credit default swap.

2. The method according to claim 1 wherein the precise knowledge input is a fundamental parameter based on knowledge of one or more input parameters.

3. The method according to claim 1 wherein the IT2 MFs capture both primary and secondary imprecision inherent to the inputs.

4. The method according to claim 1 wherein higher-order fuzzy membership functions, e.g., general type-2 membership functions and their corresponding computations are used in steps b., c. and d.

5. The method according to claim 3 wherein the fundamental input parameter value incorporates multiple SME interval estimates.

6. The method according to claim 1 wherein the calculations are based on IT2 MFs that combine the primary and secondary uncertainty of each parameter value.

7. The method according to claim 1 wherein the interval type-2 fuzzy membership functions are reduced to a corresponding interval range whose midpoint provides a notional scalar value by type-reduction.

8. The method according to claim 7 wherein the type-reduction of the FMV IT2 MF to an interval range is used in transaction negotiations to arrive at a final valuation for the financial instrument.

9. The method according to claim 7 wherein the type-reduction of the FMV IT2 MF to an interval range is used by accountants, appraisers, or bankers for advising and financing the buyers or sellers of credit default swaps.

10. The method according to claim 1 wherein the financial instrument is a CDS valuation technique used for bonds and collateralized debt obligations.

11. The method according to claim 1 wherein the CDS is ascribed a notional value.

12. The method according to claim 10 wherein the CDS is based on a contingent stream of payments of buyers or sellers trading over-the-counter by investment banks or insurance companies, institutions such as sovereign wealth funds, state pension funds and other investment funds holding debt portfolios.

13. The method according to claim 12 wherein the CDS is ascribed a notional value.

14. The method according to claim 11 wherein the notional value is applied to options pricing.

15. The method according to claim 12 wherein the CDS further includes a Black-Scholes model for evaluating a contingent stream of payments.

16. The method according to claim 15 wherein the CDS further includes extensions of the Black-Scholes model, for example the binomial pricing model.

17. The method according to claim 11 wherein the CDS provides a discounted price.

18. The method according to claim 11 wherein the CDS provides no discounted price.

19. The method according to claim 18 wherein the CDS is specified over a defined lifetime or for a variable period.

20. The method according to claim 18 where the CDS provides a specific upfront payment per unit used as a negotiated value.

21. A computer for assessing a FMV payment stream for a CDS comprising:
a. a processor;
b. a display device;
c. a storage device; and
d. a memory, the memory comprising software instructions, the software instructions comprising instructions for:
i. estimating the IT2 MF of a FMV for a contingent payment stream for a CDS of claim 1;
ii. type-reducing the IT2 MF to a negotiation interval;
iii. calculating the midpoint of the negotiation interval as a notional scalar FMV; and
iv. displaying these results on the display device to show the expected FMV IT2 MF and its derived components in ii. and iii.

22. The computer in claim 21 where the computer displays the FMV for a contingent payment stream.

23. The computer in claim 21 where the computer display for the CDS is selected from the group consisting of spread payments, swapping rights, and combinations thereof.

24. A server for estimating the FMV payment stream for a CDS comprising:
a. a processor;
b. a network to which the processor is connected;
c. a storage device connected to the processor; and
d. a memory, the memory comprising software instructions, the software instructions comprising instructions for:
i. receiving over the network information related to the calculation of the FMV of a contingent payment stream for the CDS of claim 1; and
ii. returning the results over the network information related to the calculation of the FMV of a contingent payment stream of claim 1.

25. The server of claim 24 for estimating the FMV payment stream wherein the network is selected from the group consisting of the Internet, intranet, local area networks (LANS), wide area networks (WANS), and a wireless network.

26. The server of claim 24 for estimating the FMV payment stream wherein the network comprises a plurality of interconnected networks.

27. The server of claim 24 for estimating the FMV payment stream where the CDS is selected from the group consisting of royalties, options on royalties, streaming contracts, and combinations thereof.
